(19) United States
(12) Patent Application Publication
(10) Pub. No.: US 2013/0150058 A1
(43) Pub. Date: Jun. 13, 2013

(54) METHOD OF CONTROLLING COMMUNICATION RESOURCES FOR CELLULAR MOBILE COMMUNICATION SYSTEM-BASED DEVICE-TO-DEVICE COMMUNICATION

(71) Applicants: Soon Youg LIM, Daejeon (KR); Mi Jeong YANG, Daejeon (KR); Ae Soon PARK, Daejeon (KR)

(72) Inventors: Soon Youg LIM, Daejeon (KR); Mi Jeong YANG, Daejeon (KR); Ae Soon PARK, Daejeon (KR)

(73) Assignee: Electronics & Telecommunications Research Institute, Daejeon (KR)

(21) Appl. No.: 13/529,231

(22) Filed: Jun. 21, 2012

(30) Foreign Application Priority Data
Dec. 7, 2011 (KR) 10-2011-0130048

(51) Int. Cl. H04W 72/04; H04W 52/04

(52) U.S. Cl. 455/450

(57) ABSTRACT

Provided is a method of controlling communication resources for cellular mobile communication system-based device-to-deice (D2D) communication. The method includes selecting, at a base station, at least two devices, which are performing cellular communication in the same cell, as D2D candidates, measuring environment-based information on the selected D2D candidates to select at least one D2D pair, and allocating uplink (UL) resources or downlink (DL) resources to the D2D pair.

### CLAIM FOR PRIORITY

This application claims priority to Korean Patent Application No. 10-2011-0130048 filed on Dec. 07, 2011 in the Korean Intellectual Property Office (KIPO), the entire contents of which are hereby incorporated by reference.

### BACKGROUND

1. Technical Field

Example embodiments of the present invention relate in general to a method of controlling direct communication between devices, and more particularly, to a method of controlling communication resources for cellular mobile communication system-based device-to-device (D2D) communication.

2. Related Art

Direct communication between terminals is a communication method in which two adjacent terminals perform direct data transmission and reception without passing through a base station. In other words, the two terminals communicate as a source and a destination of data, respectively.

With the drastic increase of data traffic resulting from the proliferation of various communication terminals, high network capacity, a high data transmission rate, high service quality, etc. are needed to provide service to many users. For this reason, in a cellular mobile communication system, direct communication is used between devices.

FIG. 1 is a conceptual diagram of direct communication between terminals.

Referring to FIG. 1, a cellular communication network includes a first base station and a second base station. While user equipment (UE) 1 to UE 3 belonging to a cell generated by the first base station perform communication using a general access link through the first base station, UE 4 and UE 5 belonging to the first base station directly perform data transmission and reception with each other without passing through a base station.

Various discussions may be made on a user case in which such direct communication between terminals can be efficiently used. For example, direct communication between terminals may be used in a local media server that provides a large amount of data (e.g., programs of a rock concert, and information on a musician) to participants at a rock concert and so on. Here, respective devices connect to a serving cell and perform telephone communication, Internet access, etc. using an existing cellular link. The respective devices may directly exchange the aforementioned large amount of data received from the local media server operating as a counterpart of D2D communication according to a D2D scheme.

Meanwhile, referring back to FIG. 1, a D2D link is allowed not only between UE (devices) having the same cell as a serving cell but also between UE (devices) having different cells as serving cells. For example, the UE 3 belonging to the first base station may perform D2D communication with the UE 6 belonging to the second base station.

Such a D2D link may be provided according to a communication scheme using an unlicensed band of a wireless local area network (WLAN), such as Institute of Electrical and Electronics Engineers (IEEE) 802.11, Bluetooth, or so on. However, in the communication scheme using such an unlicensed band, it is difficult to provide a scheduled and controlled service. In particular, the performance of the communication scheme may drastically deteriorate due to interference.

On the other hand, D2D communication provided by a wireless communication system using a licensed band or a television (TV) white space band employed in an environment in which interference between systems is controlled can support quality of service (QoS), enhance frequency use efficiency through frequency reuse in a D2D link, and increase a D2D communication distance.

The aforementioned direct communication between terminals requires a D2D link. A D2D link denotes a communication scheme in which devices belonging to the same cell or different cells exchange data through direct communication between them without passing through a network.

To enable such direct communication between terminals in a current cellular communication system, problems relating to 1) a method of examining whether it is possible to establish a D2D link between communication counterpart devices, 2) a method of determining radio resources for a D2D communication link between devices, 3) a method of scheduling data transmission and reception between devices, 4) a hybrid automatic repeat request (HARQ) and adaptive wireless transmission method between devices, etc. need to be solved.

In particular, technology relating to a D2D pairing means and method is inadequate for a method of determining radio resources for a D2D communication link between devices.

### SUMMARY

Accordingly, example embodiments of the present invention are provided to substantially obviate one or more problems due to limitations and disadvantages of the related art.

Example embodiments of the present invention provide a communication resource allocation method causing device-to-device (D2D) communication to use the same resource as general users in a cellular-based mobile communication system.

Example embodiments of the present invention also provide improved communication quality in a cellular-based mobile communication system by minimizing mutual interference while D2D communication uses the same resource as general users.

In some example embodiments, a method of controlling communication resources for cellular mobile communication system-based D2D communication includes: selecting, at a base station, at least two devices, which are performing cellular communication in the same cell, as D2D candidates; measuring environment-based information on the selected D2D candidates to select at least one D2D pair; and allocating uplink (UL) resources to the D2D pair.

Here, selecting the at least two devices as the D2D candidates may include selecting the D2D candidates on the basis of geographic coordinates of the at least two devices.

Here, the environment-based information may be a distance between the at least two devices, which are the D2D candidates, or a distance between the D2D candidates and the base station.

Here, allocating the UL resources may include controlling transmission power P for D2D communication of the D2D pair and transmission power P_{U} of another device in the cell not to overlap each other.

In other example embodiments, a method of controlling communication resources for cellular mobile communication system-based D2D communication includes: selecting, at a base station, at least two devices, which are performing cellular communication in the same cell, as D2D candidates; measuring environment-based information on the selected D2D candidates to select at least one D2D pair; and allocating downlink (DL) resources to the D2D pair.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of direct communication between devices;

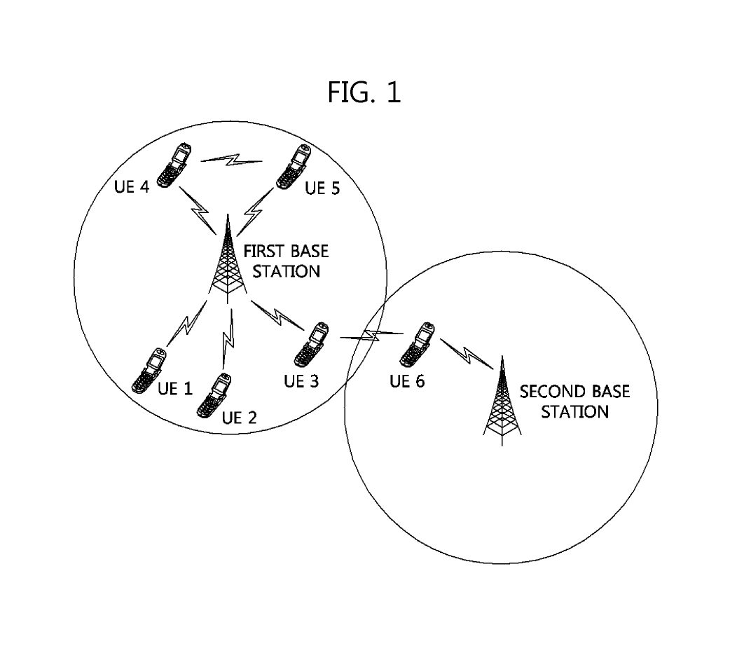

FIG. 2 is a conceptual diagram illustrating a case of allocating uplink (UL) resources to direction communication between devices according to an example embodiment of the present invention;

FIG. 3 is a flowchart illustrating a method of allocating UL resources to direction communication between devices according to an example embodiment of the present invention;

FIG. 4 is a conceptual diagram illustrating a case of allocating downlink (DL) resources to direction communication between devices according to another example embodiment of the present invention; and

FIG. 5 is a flowchart illustrating a method of allocating DL resources to direction communication between devices according to another example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The term “user equipment (UE)” used herein may be referred to as a mobile station (MS), user terminal (UT), wireless terminal, access terminal (AT), terminal, subscriber unit, subscriber station (SS), wireless device, wireless communication device, wireless transmit/receive unit (WTRU), mobile node, mobile, or other terms. Various example embodiments of UE may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or UE having a combination of such functions, but are not limited to these.

The term “base station” used herein generally denotes a fixed or moving point communicating with a device, and may be referred to as a Node-B, evolved Node-B (eNB), base transceiver system (BTS), access point (AP), relay, femtocell, and other terms.

A plurality of UE (devices) are allocated radio resources and provided with a mobile communication service. Radio resources are common resources of a cell. A plurality of users are competitively allocated the radio resources, and resources allocated to one user may be exclusive to other users.

Hereinafter, example embodiments of the present invention will be described in detail with reference to the accompanying drawings.

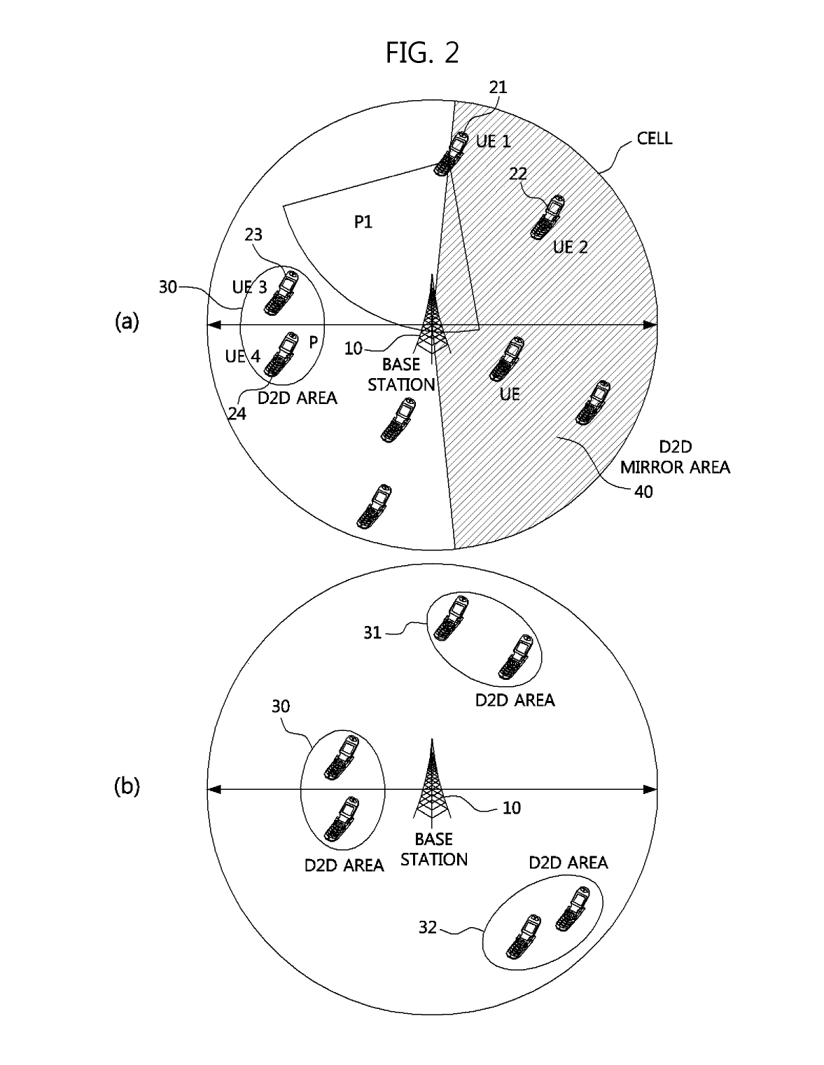

FIG. 2 is a conceptual diagram illustrating a case of allocating uplink (UL) resources to direction communication between devices according to an example embodiment of the present invention.

Referring to FIG. 2(A), a plurality of UE are present in a cell area handled by a base station 10. In a device-to-device (D2D) area 30, D2D communication, that is, direct communication between UE3 23 and UE4 24, is performed. The two devices, that is, the UE3 23 and the UE4 24, forming the D2D area 30 are referred to as a D2D pair. Also, the cell area outside of the D2D area 30 is referred to as a D2D mirror area 40. When UE1 21 transmits data using UL resources, transmission power P1 of the UE1 21 reaches an appropriate level for the base station 10. Meanwhile, when the D2D pair uses UL resources, transmission power P for D2D communication of the D2D pair handles D2D communication in the D2D area 30.

Thus, to perform D2D communication by allocating UL resources, P1 and P need to be controlled to handle communication in areas that do not overlap, as shown in FIG. 2(A).

Also, as shown in FIG. 2(B), a plurality of D2D areas 30, 31 and 32 may be set in the cell by selecting other D2D pairs. In other words, when UL resources are allocated to D2D communication, the D2D communication may be extended by selecting a plurality of D2D pairs.

### Embodiment #1 in which UL Resources are Allocated to Direct D2D Communication

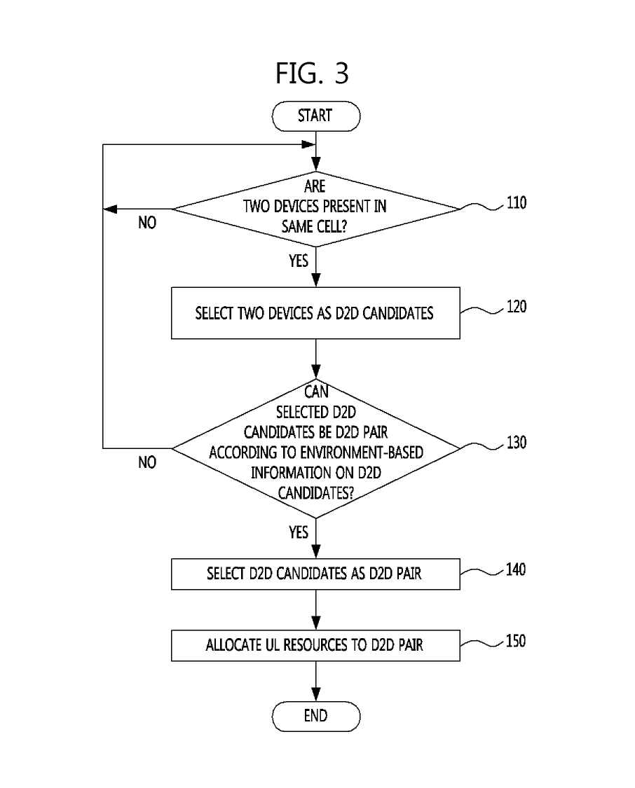

FIG. 3 is a flowchart illustrating a method of allocating UL resources to direction communication between devices according to an example embodiment of the present invention.

Referring to FIG. 3, a base station 10 checks whether at least two devices are in the same cell (110). When at least two devices are in the same cell, the at least two devices are selected as D2D candidates (120). Environment-based information on the selected D2D candidates is collected and analyzed to determine whether the D2D candidates can be selected as a D2D pair (130). In general, it is preferable to select sets of UE adjacent to each other as a D2D pair. After a D2D pair is determined on the basis of the environment-based information (140), UL resources are allocated to the D2D pair (150).

For this, an example embodiment of the present invention provides a method of controlling communication resources for cellular mobile communication system-based D2D communication including a step in which the base station 10 selects at least two devices, which are performing cellular communication in the same cell, as D2D candidates (120), a step of measuring environment-based information on the selected D2D candidates to select at least one D2D pair (140), and a step of allocating UL resources to the D2D pair (150).

In the step in which the base station 10 selects the at least two devices performing cellular communication in the same cell as the D2D candidates (120), the D2D candidates may be selected on the basis of geographic coordinates of the at least two devices. For example, when the respective devices include positioning apparatuses such as global positioning system (GPS) apparatuses, the positioning apparatuses may be used to obtain the geographic coordinates of the at least two devices, or the geographic coordinates of the at least two devices may be obtained by the base station 10 using another positioning scheme.

Here, in the step of measuring the environment-based information on the selected D2D candidates to select the D2D pair (140), the environment-based information may be a distance between the at least two devices, which are the D2D candidates, or a distance between the D2D candidates and the base station 10. In other words, when the distance between the at least two devices or the distance between the D2D candidates and the base station 10 exceeds a predetermined value, it is preferable not to select the devices as a D2D pair.

In the step of allocating the UL resources to the D2D pair (150), transmission power P for D2D communication of the D2D pair and transmission power P_{U} of another device in the cell need to be controlled not to overlap. The transmission power P for D2D communication is electric power transmitted for D2D communication by UE in a D2D area 30, and the transmission power P_{U} of the other device in the cell is electric power transmitted by the device, which does not form a D2D area in the cell, to communicate with the base station 10. Thus, interference between P and P_{U} needs to be minimized.

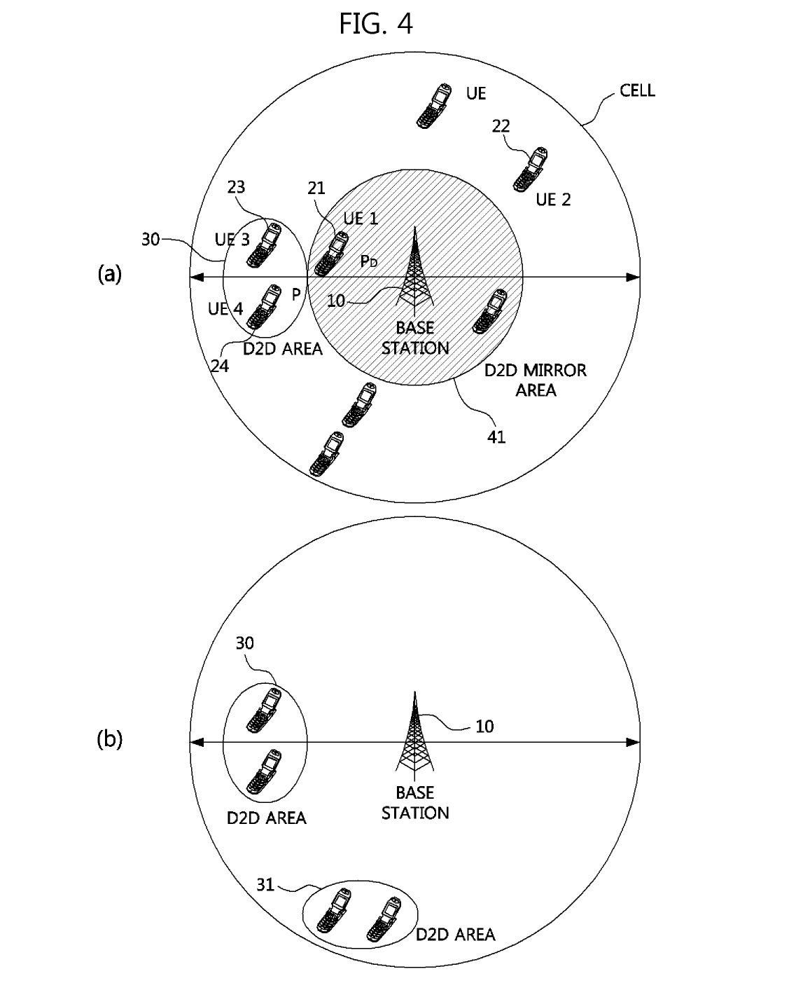

FIG. 4 is a conceptual diagram illustrating a case of allocating downlink (DL) resources to direction communication between devices according to another example embodiment of the present invention.

Referring to FIG. 4(A), a plurality of UE (devices) are present in a cell area handled by a base station 10. In a D2D area 30, D2D communication, that is, direct communication between UE3 23 and UE4 24, is performed. The two devices, that is, the UE3 23 and the UE4 24, forming the D2D area 30 are referred to as a D2D pair. Also, the cell area outside of the D2D area 30 is referred to as a D2D mirror area 41, which is different from the D2D minor area 40 of FIG. 2(A). When UE1 21 receives data using DL resources, transmission power P_{D} at the base station 10 reaches an appropriate level for the UE1 21. Meanwhile, when the D2D pair uses DL resources, transmission power P for D2D communication of the D2D pair handles D2D communication in the D2D area 30.

Thus, to perform D2D communication by allocating DL resources, P_{D} and P need to be controlled to handle communication in areas that do not overlap, as shown in FIG. 4(A).

Also, as shown in FIG. 4(B), a plurality of D2D areas 30 and 31 may be set in the cell by selecting another D2D pair. In other words, when DL resources are allocated to D2D communication, the D2D communication may be extended by selecting a plurality of D2D pairs.

### Embodiment #2 in which DL Resources are Allocated to Direct D2D Communication

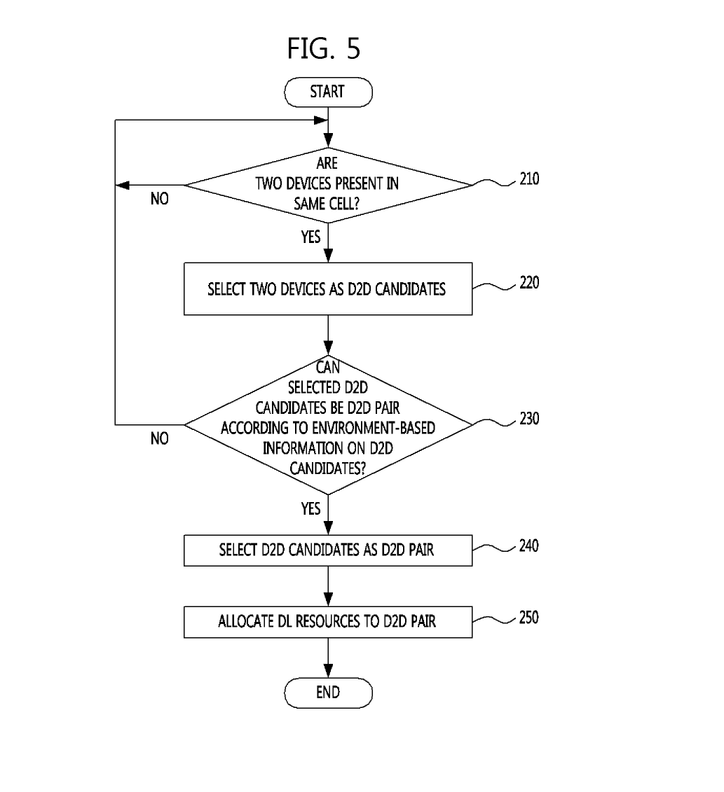

FIG. 5 is a flowchart illustrating a method of allocating DL resources to direction communication between devices according to an example embodiment of the present invention.

Referring to FIG. 5, a base station 10 checks whether at least two devices are in the same cell (210). When at least two devices are in the same cell, the at least two devices are selected as D2D candidates (220). Environment-based information on the selected D2D candidates is collected and analyzed to determine whether the D2D candidates can be selected as a D2D pair (230). In general, it is preferable to select sets of UE adjacent to each other as a D2D pair. After a D2D pair is determined on the basis of the environment-based information (240), DL resources are allocated to the D2D pair (250).

Hereupon, an example embodiment of the present invention provides a method of controlling communication resources for cellular mobile communication system-based D2D communication including a step in which the base station 10 selects at least two devices, which are performing cellular communication in the same cell, as D2D candidates (220), a step of measuring environment-based information on the selected D2D candidates to select at least one D2D pair (240), and a step of allocating DL resources to the D2D pair (250).

In the step in which the base station 10 selects the at least two devices performing cellular communication in the same cell as the D2D candidates (220), the D2D candidates may be selected on the basis of geographic coordinates of the at least two devices. For example, when the respective devices include positioning apparatuses such as GPS apparatuses, the positioning apparatuses may be used to obtain the geographic coordinates of the at least two devices, or the geographic coordinates of the at least two devices may be obtained by the base station 10 using another positioning scheme.

Here, in the step of measuring the environment-based information on the selected D2D candidates to select the D2D pair (240), the environment-based information may be a distance between the at least two devices, which are the D2D candidates, or a distance between the D2D candidates and the base station 10. In other words, when the distance between the at least two devices or the distance between the D2D candidates and the base station 10 exceeds a predetermined value, it is preferable not to select the devices as a D2D pair.

In the step of allocating the DL resources to the D2D pair (250), transmission power P for D2D communication of the D2D pair and reception power P_{D} of another device in the cell need to be controlled not to overlap. The transmission power P for D2D communication is electric power transmitted for D2D communication by UE in a D2D area 30, and the reception power P_{D} of the other device in the cell is electric power received from the base station 10 by the device, which does not form a D2D area in the cell, to communicate with the base station 10. Thus, interference between P and P_{D} needs to be minimized.

In cellular mobile communication-based D2D communication, a configuration of the present invention enables a D2D pair to use the same communication resources (UL resources or DL resources) as general users, and provides a position-based D2D communication resource allocation method of controlling power to minimize mutual interference.

In the above-described method of controlling communication resources for cellular mobile communication system-based D2D communication according to an example embodiment of the present invention, it is possible to use the same communication resources as general users, such that communication resources can be efficiently used.

Also, using the method of controlling communication resources for cellular mobile communication system-based D2D communication according to an example embodiment of the present invention, mutual interference is minimized, and thereby deterioration or discontinuance of communication quality is prevented.

Advantages of the present invention are not limited to those mentioned above, and unmentioned other advantages will be clearly understood by those of ordinary skill in the art from the claims.

While the example embodiments of the present invention and their advantages have been described in detail, it should be understood that various changes, substitutions and alterations may be made herein without departing from the scope of the invention.

What is claimed is:

1. A method of controlling communication resources for cellular mobile communication system-based device-to-device (D2D) communication, comprising:
selecting at least two devices, which are performing cellular communication in the same cell, as D2D candidates;
measuring environment-based information on the selected D2D candidates to select at least one D2D pair; and
allocating uplink (UL) resources to the D2D pair.

2. The method of claim 1, wherein selecting the at least two devices as the D2D candidates includes selecting the D2D candidates on the basis of geographic coordinates of the at least two devices.

3. The method of claim 1, wherein the environment-based information is a distance between the at least two devices, which are the D2D candidates, or a distance between the D2D candidates and a base station.

4. The method of claim 1, wherein allocating the UL resources includes controlling transmission power for D2D communication of the D2D pair and transmission power of another device in the cell not to overlap.

5. A method of controlling communication resources for cellular mobile communication system-based device-to-deice (D2D) communication, comprising:
selecting, at a base station, at least two devices, which are performing cellular communication in the same cell, as D2D candidates;
measuring environment-based information on the selected D2D candidates to select at least one D2D pair; and
allocating downlink (DL) resources to the D2D pair.

6. The method of claim 5, wherein selecting the at least two devices as the D2D candidates includes selecting the D2D candidates on the basis of geographic coordinates of the at least two devices.

7. The method of claim 5, wherein the environment-based information is a distance between the at least two devices, which are the D2D candidates, or a distance between the D2D candidates and the base station.

8. The method of claim 5, wherein allocating the DL resources includes controlling transmission power for D2D communication of the D2D pair and reception power of another device in the cell not to overlap each other.
